(19) United States
(12) Patent Application Publication
(10) Pub. No.: US 2020/0126001 A1
(43) Pub. Date: Apr. 23, 2020

(54) INFORMATION PROCESSING SYSTEM, NON-TRANSITORY STORAGE MEDIUM STORING PROGRAM, AND INFORMATION PROCESSING METHOD

(71) Applicant: TOYOTA JIDOSHA KABUSHIKI KAISHA, Toyota-shi (JP)

(72) Inventor: Kazuya Nishimura, Okazaki-shi (JP)

(73) Assignee: TOYOTA JIDOSHA KABUSHIKI KAISHA, Toyota-shi (JP)

(21) Appl. No.: 16/516,595

(22) Filed: Jul. 19, 2019

(30) Foreign Application Priority Data
Oct. 23, 2018 (JP) 2018-199416

(51) Int. Cl. G06Q 10/02

(52) U.S. Cl. CPC G06Q 10/02

(57) ABSTRACT

An information processing system includes a reservation system that manages a use reservation of a service and a server capable of communicating with the reservation system. When the use reservation of the service is detected, the reservation system transmits reservation information including identification information of the use reservation to the server. When a cancellation of the use reservation is detected, the reservation system transmits cancellation information including the identification information to the server. When the reservation information is received from the reservation system, the server stores the reservation information. When the cancellation information is received, the server determines a degree of influence of the cancellation on a service provider and transmits use promoting information that enables a service user to use the service under a more beneficial condition as the degree of influence is greater to a terminal device of a user.

### INCORPORATION BY REFERENCE

The disclosure of Japanese Patent Application No. 2018-199416 filed on Oct. 23, 2018 including the specification, drawings and abstract is incorporated herein by reference in its entirety.

### BACKGROUND

### 1. Technical Field

The disclosure relates to an information processing system, a non-transitory storage medium storing a program, and an information processing method.

### 2. Description of Related Art

In the related art, an information processing technique is applied to provide a product or a service. For example, Japanese Unexamined Patent Application Publication No. 2015-041339 (JP 2015-041339 A) discloses that when a reservation request for a restaurant is received from a vehicle, reservation processing of the restaurant is performed based on at least one of position information and the reservation request of the vehicle. Further, for example, WO 2017/098803 discloses that when there is a vacant seat, an offer such as adoption of more beneficial discount rate or a coupon is provided to a potential customer with a short movement time to a store and a less beneficial offer is provided to a potential customer who arrives at the store after a time during which the vacant seat is predicted.

### SUMMARY

For example, at a service providing store such as a restaurant, a form where a user reserves a use date and time and the number of users in advance is generally adopted. The reservation information by the user is useful for a service provider since the information can be used, for example, for business management such as operation rate management and profit estimation of the store. Therefore, when a reservation is canceled and there is no another service user during a reservation time zone, it may cause an undesirable influence such as an occurrence of lost profits or loss on the service provider.

The present disclosure reduces an influence of a reservation cancellation on a service provider.

A first aspect of the disclosure provides an information processing system. The information processing system includes: reservation system that manages a use reservation of a service; and a server configured to communicate with the reservation system, wherein: the reservation system is configured to transmit, to the server, reservation information including identification information of the use reservation to the server when an occurrence of the use reservation of the service is detected by the reservation system, and transmit, to the server, cancellation information including the identification information of the use reservation to the server when an occurrence of a cancellation of the use reservation is detected by the reservation system; and the server is configured to store the reservation information when the reservation information is received from the reservation system, determine a degree of influence of the cancellation on a provider of the service when the cancellation information is received from the reservation system, and transmit, to a terminal device of a user, use promoting information that enables a service user to use the service under a more beneficial condition as the degree of influence is greater to a terminal device of a user.

A second aspect of the disclosure provides non-transitory storage medium storing a program causing a server configured to communicate with a reservation system that manages a use reservation of a service to execute: receiving reservation information including identification information of the use reservation from the reservation system that detects an occurrence of the use reservation of the service; storing the received reservation information; receiving cancellation information including the identification information of the use reservation from the reservation system that detects an occurrence of a cancellation of the use reservation; determining a degree of influence of the cancellation on a provider of the service; and transmitting, to a terminal device of a user, use promoting information that enables a service user to use the service under a more beneficial condition as the degree of influence is greater.

A third aspect of the disclosure provides an information processing method including: causing a reservation system that manages a use reservation of a service to transmit, to a server configured to communicate with the reservation system, reservation information including identification information of the use reservation of the service when an occurrence of the use reservation of the service is detected by the reservation system; causing the server to store the reservation information when the server receives the reservation information from the reservation system; causing the reservation system to transmit, to the server, cancellation information including the identification information of the use reservation when an occurrence of a cancellation of the use reservation is detected by the reservation system; causing the server to determine a degree of influence of the cancellation on a provider of the service when the cancellation information is received from the reservation system; and causing the server to transmit, to a terminal device of a user, use promoting information that enables a service user to use the service under a more beneficial condition as the degree of influence is greater.

With an information processing system, a non-transitory storage medium storing a program, and an information processing method according to the above aspects of the disclosure, it is possible to reduce an influence of a reservation cancellation on a service provider.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a schematic configuration of an information processing system according to an embodiment of the disclosure;

FIG. 2 is a block diagram showing a schematic configuration of a reservation system;

FIG. 3 is a block diagram showing a schematic configuration of a server;

FIG. 4 is a table showing an example of information stored in the server;

FIG. 5 is a flowchart showing an operation of the reservation system; and

FIG. 6 is a flowchart showing an operation of the server.

### DETAILED DESCRIPTION OF EMBODIMENTS

Hereinafter, the embodiment of the disclosure will be described.

### Configuration of Information Processing System

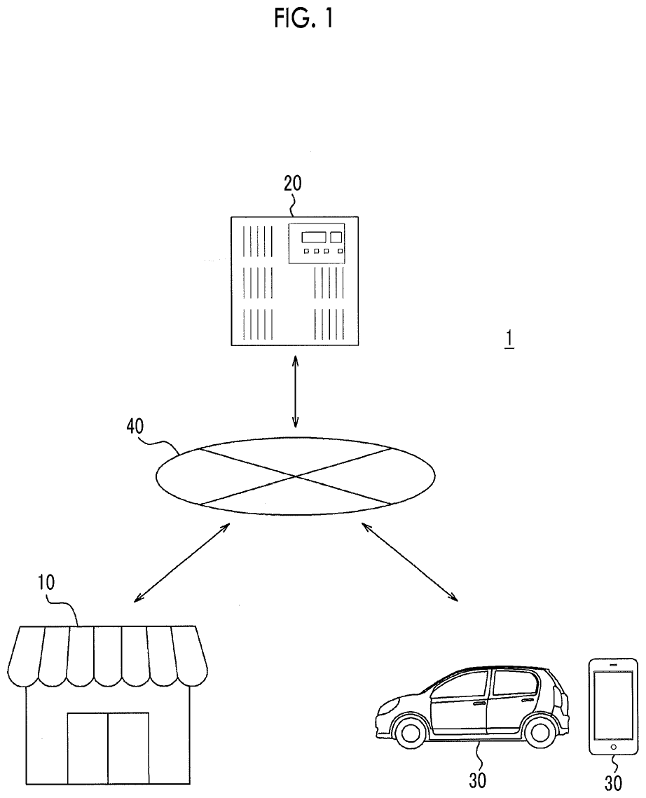

An outline of an information processing system 1 according to an embodiment of the disclosure will be described with reference to FIG. 1. The information processing system 1 comprises a reservation system 10, a server 20, and one or more terminal device 30. The reservation system 10, the server 20, and the terminal device 30 are connected to a network 40 including, for example, a mobile communication network and the Internet in a communicable manner.

The reservation system 10 is used by a service provider who provides a reservation system service. The reservation system 10 includes one or a plurality of information processing devices capable of communicating with each other. The reservation system 10 manages a use reservation of the service from a user. The server 20 includes one or a plurality of server devices capable of communicating with each other.

The terminal device 30 is used by the user using the service. In the embodiment, the terminal device 30 will be described as a movable device such as a vehicle having an on-vehicle communication device such as data communication module (DCM) or a smartphone, but is not limited thereto and may be a predetermined device such as a personal computer (PC). The user can perform the use reservation of the service by using, for example, the terminal device 30.

First, an outline of the embodiment will be described, and details will be described below. When an occurrence of a use reservation of the service is detected, the reservation system 10 transmits reservation information to the server 20. On the other hand, when an occurrence of a cancellation of the use reservation is detected, the reservation system 10 transmits cancellation information to the server 20. When cancellation information from the reservation system 10 is received, the server 20 determines a degree of influence of the cancellation on the service provider. The server 20 transmits use promoting information to the terminal device 30, which enables the user to use the service under a beneficial condition as the degree of influence is greater. Specifically, the use promoting information may include a benefit (for example, so-called electronic coupon) of the user at the time of the service use such as reduction of an expense needed to be paid by the user for receiving the provision of the service or improvement in the number of services or quality of the service to be provided to the user. For example, as the degree of influence of the cancellation on the service provider is greater, the expense needed to be paid by the user is largely reduced, or the number of services or the quality of the service to be provided to the user is largely improved.

In this manner, according to the embodiment, the degree of influence of the cancellation of the use reservation on the service provider is determined, and the use promoting information according to the degree of influence is provided to the user. Therefore, even when the cancellation of the use reservation of the service occurs, the lost profits of the service provider may be offset by a customer attraction effect of the use promoting information according to the degree of influence. As a result, the influence of the reservation cancellation on the service provider may be reduced.

Next, each configuration of the information processing system 1 will be described in detail.

### Configuration of Reservation System

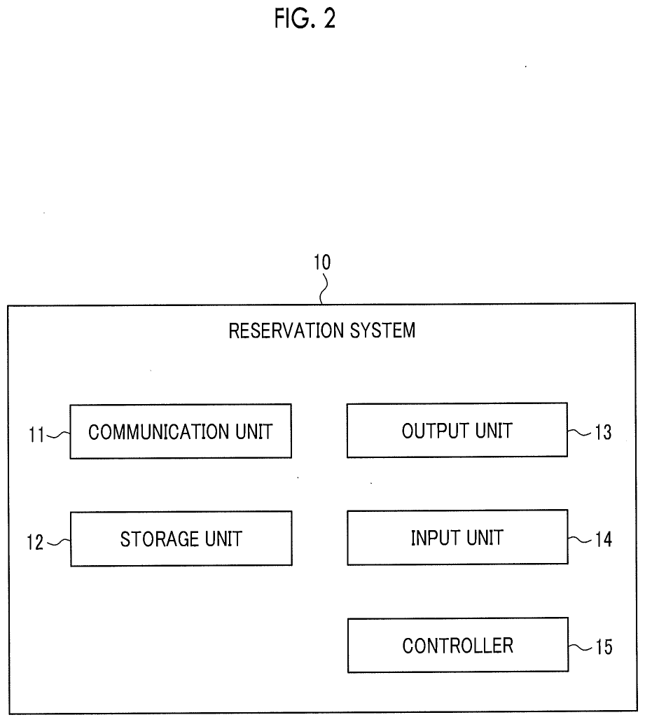

As shown in FIG. 2, the reservation system 10 comprises a communication unit 11, a storage unit 12, an output unit 13, an input unit 14, and a controller 15.

The communication unit 11 includes one or more communication modules to be connected to the network 40. For example, the communication unit 11 may include a communication module supporting a wired local area network (LAN) standard and a wireless LAN standard. In the embodiment, the reservation system 10 is connected to the network 40 through the communication unit 11.

The storage unit 12 includes one or more memories. In the embodiment, an example of the “memory” is a semiconductor memory, a magnetic memory, or an optical memory, but is not limited thereto. Each memory included in the storage unit 12 may function as, for example, a main storage device, an auxiliary storage device, or a cache memory. The storage unit 12 stores predetermined information used for the operation of the reservation system 10. For example, the storage unit 12 may store a system program, an application program, and the like. The information stored in the storage unit 12 may be updatable with, for example, information to be acquired from the network 40 through the communication unit 11.

The output unit 13 includes one or more output interfaces that output the information to perform notification to the user. For example, an example of the output interface included in the output unit 13 is a display that outputs the information as video or a speaker that outputs the information as sound, but is not limited thereto. In the embodiment, the “video” may include a text, a still image, and a moving image.

The input unit 14 includes one or more input interfaces that detect user inputs. For example, an example of the input interface included in the input unit 14 is a physical key, a capacitance type key, a touch screen provided integrally with the display of the output unit 13, or a microphone accepting a sound input, but is not limited thereto.

The controller 15 comprises one or more processors. In the embodiment, an example of the “processor” is a general purpose processor or a dedicated processor specialized for specific processing, but is not limited thereto. The controller 15 controls the entire operation of the reservation system 10.

For example, the controller 15 determines whether the occurrence of the use reservation of the service is detected. Specifically, when a use reservation request of the service is received from the terminal device 30 of a service use applicant through the communication unit 11 and determination is made that the reservation is acceptable based on the number of reservation people and a reservation time zone, the controller 15 may determine that the occurrence of the use reservation of the service is detected. Alternatively, when a user input, by an operator (for example, staff or the like at service providing location) who receives a telephone call from the service use applicant, that registers the use reservation of the service is detected, the controller 15 may determine that the occurrence of the use reservation of the service is detected.

When the determination is made that the occurrence of a use reservation of the service is detected, the controller 15 stores the reservation information in the storage unit 12 and transmits the information to the server 20. Here, the “reservation information” includes, for example, identification information of the use reservation (hereinafter also referred to as “reservation ID”), the number of users of the service (hereinafter also referred to as the “number of reservation people”), a time point that starts the use of the service (hereinafter also referred to as “reservation start time point”), and a time point that ends the use of the service (hereinafter also referred to as “reservation end time point”). However, the information included in the reservation information is not limited to the above, and may include predetermined information on the reservation such as reservation person information (name, age, gender, mail address, and the like) and service contents (for example, order contents in the food and drink providing service).

For example, the controller 15 determines whether the occurrence of the cancellation of the use reservation is detected. Specifically, when a cancellation request of the use reservation is received from the terminal device 30 of a service use reservation person through the communication unit 11, the controller 15 may determine that the occurrence of the cancellation of the use reservation is detected. Alternatively, when a user input, by an operator who receives a telephone call from the service use reservation person, that registers the cancellation of the use reservation is detected, the controller 15 may determine that the occurrence of the cancellation of the use reservation is detected.

Alternatively, when a confirmation notification is transmitted to the terminal device 30 of the service use reservation person and there is no response from the terminal device 30 by a predetermined time before the reservation start time point, the controller 15 may determine that the occurrence of the cancellation of the use reservation is detected.

When the determination is made that the occurrence of the cancellation of the use reservation is detected, the controller 15 transmits the cancellation information to the server 20. Here, the “cancellation information” includes, for example, a reservation ID of the canceled use reservation and a time point where the determination is made that the occurrence of the cancellation is detected (hereinafter also referred to as “cancellation occurrence time point”). However, the information included in the cancellation information is not limited to the above, and may include predetermined information on the cancellation of the use reservation. The controller 15 deletes the reservation information related to the canceled use reservation from the storage unit 12.

In the transmission of the cancellation information, the controller 15 may transmit the cancellation information when determination is made whether a time from the cancellation occurrence time point of the use reservation to the reservation start time point is less than a predetermined threshold value and determination is made that the time is less than the threshold value.

### Configuration of Server

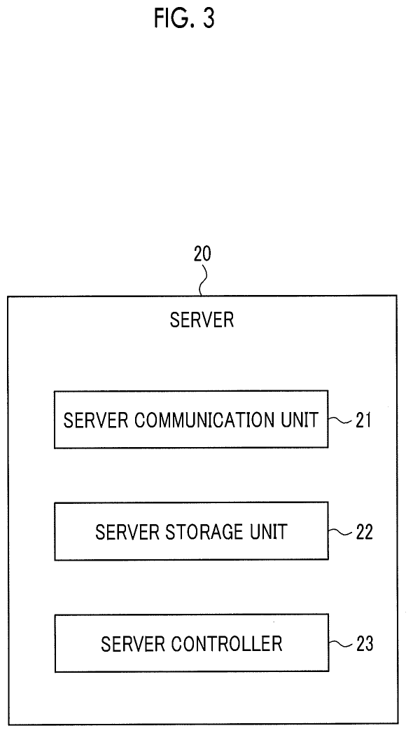

As shown in FIG. 3, the server 20 comprises a server communication unit 21, a server storage unit 22, and a server controller 23.

The server communication unit 21 includes one or more communication modules to be connected to the network 40. For example, the server communication unit 21 may include a communication module supporting the wired local area network (LAN) standard. In the embodiment, the server 20 is connected to the network 40 through the server communication unit 21.

The server storage unit 22 includes one or more memories. Each memory included in the server storage unit 22 may function as, for example, the main storage device, the auxiliary storage device, or the cache memory. The server storage unit 22 stores predetermined information used for the operation of the server 20. For example, the server storage unit 22 may store the system program, the application program, a database accumulating information to be received from the reservation system 10, and the like. The information stored in the server storage unit 22 may be updatable with, for example, information to be acquired from the network 40 through the server communication unit 21.

The server controller 23 includes one or more processors. The server controller 23 controls the entire operation of the server 20.

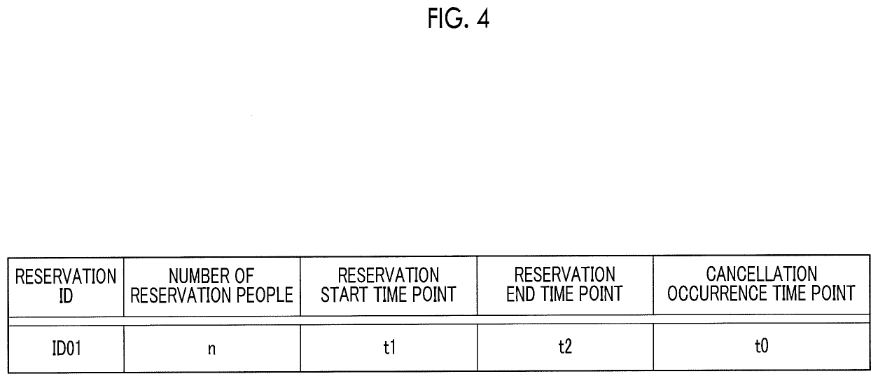

For example, when reservation information related to the use reservation of the service is received from the reservation system 10 through the server communication unit 21, the server controller 23 stores the reservation information in the database of the server storage unit 22. For example, when the reservation information includes the reservation ID, the number of reservation people, the reservation start time point, and the reservation end time point, these pieces of information are stored in the database. For example, as shown in FIG. 4, a reservation ID “r01”, the number of reservation people “n”, a reservation start time point “t1”, and a reservation end time point “t2” are stored in the database. However, t0<t1<t2.

For example, when cancellation information related to the canceled use reservation is received from the reservation system 10 through the server communication unit 21, the server controller 23 stores a cancellation occurrence time point, included in the cancellation information, in the database of the server storage unit 22. For example, as shown in FIG. 4, the cancellation occurrence time point “t0” is stored in the database in association with the reservation ID included in the cancellation information.

When the cancellation occurrence time point is stored in the database, the server controller 23 determines the degree of influence of the cancellation on the service provider.

Here, a determination method of the degree of influence of the cancellation on the service provider will be described. In general, when the use reservation of the service is canceled, there is a high probability that the lost profits or loss of the service provider becomes larger as the number of reservation people of the canceled use reservation is larger. Therefore, when the reservation information described above includes the number of reservation people (that is, when the number of reservation people is stored in database), the server controller 23 may determine that the degree of influence is greater as the number of reservation people (n in example shown in FIG. 4) of the use reservation corresponding to the reservation ID included in the cancellation information is larger with reference to the database of the server storage unit 22.

In general, when a service use reservation is canceled, there is a high probability that the lost profits or loss of the service provider becomes larger as a time from the cancellation occurrence time point to the reservation start time point is shorter. Therefore, when the reservation information described above includes the reservation start time point (that is, reservation start time point is stored in database), the server controller 23 may determine that the degree of influence is greater as the time (t1−t0) in example shown in FIG. 4) from the cancellation occurrence time point to the reservation start time point of the use reservation corresponding to the reservation ID included in the cancellation information is shorter with reference to the database of the server storage unit 22.

The determination of the degree of influence of the cancellation on the service provider is not limited to the method described above using the number of reservation people, the cancellation occurrence time point, and the reservation start time point, and a predetermined method can be adopted. For example, in general, when the use reservation of the service is canceled, there is a high probability that the lost profits or loss of the service provider becomes larger when reserved service contents (for example, order contents in food and drink providing service) are decided in advance compared with when the service contents are not decided (for example, reservation for seat solely). Therefore, the server controller 23 may determine that the degree of influence is great when the reservation information includes the service contents compared with when the information does not include the service contents.

When the degree of influence of the cancellation on the service provider is determined, the server controller 23 transmits the use promoting information, to the terminal device 30 of the user, that enables the service user to use the service under a beneficial condition as the degree of influence is greater. As described above, the “use promoting information” may include a benefit of the service user at the time of the service use such as reduction of an expense needed to be paid by the service user for receiving the provision of the service or improvement in the number of services or quality of the service to be provided to the service user. For example, as the degree of influence of the cancellation on the service provider is greater, the expense needed to be paid by the service user is largely reduced, or the number of services or the quality of the service to be provided to the service user is largely improved. However, the use promoting information is not limited to the example and may be predetermined information that promotes the use of the service by the user.

In the transmission of the use promoting information, when the reservation information described above includes the reservation start time point and the reservation end time point (that is, reservation start time point and reservation end time point are stored in database), the server controller 23 may decide a valid period (t1 to t2 in example shown in FIG. 4) from the reservation start time point to the reservation end time point of the use reservation corresponding to the reservation ID included in the cancellation information as the use promoting information with reference to the database of the server storage unit 22. For example, the user of the terminal device 30 that receives the use promoting information can receive the benefit described above solely when the service is used during the period.

The server controller 23 may transmit an implementation instruction of route guidance to a service providing location (for example, store where service is provided) to the terminal device 30 which is a transmission destination of the use promoting information. The implementation instruction may include predetermined information used for the route guidance to the service providing location, such as position information of the service providing location. The terminal device 30 that receives the implementation instruction implements the route guidance to the service providing location in response to the user input or automatically.

When the transmission of the use promoting information is completed, the server controller 23 deletes the reservation information related to the canceled use reservation from the database of the server storage unit 22.

### Operation Flow of Reservation System

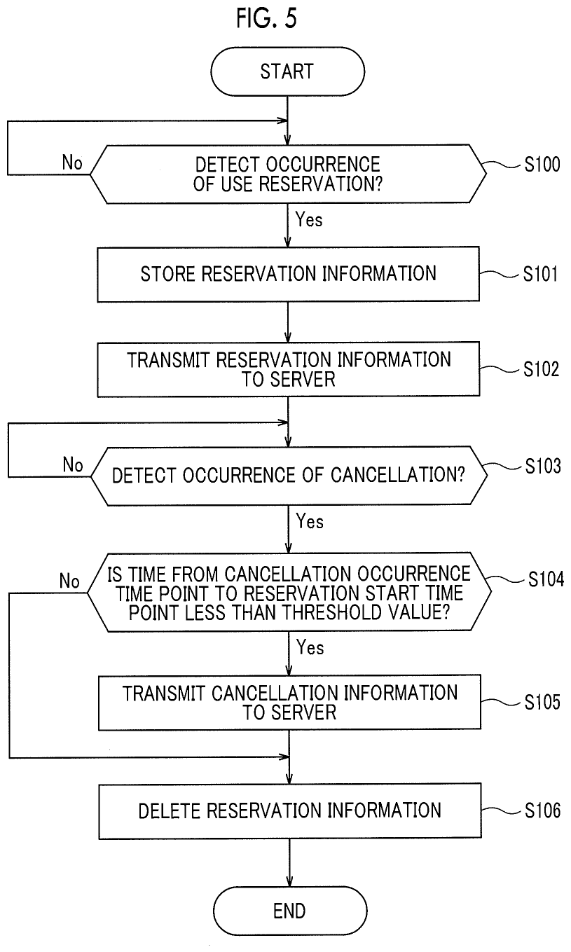

An operation flow of the reservation system 10 will be described with reference to FIG. 5.

Step S100: The controller 15 determines whether the occurrence of the use reservation of the service is detected. When determination is made that the occurrence of the use reservation is detected (Yes in step S100), the process proceeds to step S101. On the other hand, when determination is made that the occurrence of the use reservation is not detected (No in step S100), the process repeats step S100.

Step S101: The controller 15 stores the reservation information of the use reservation in the storage unit 12.

Step S102: The controller 15 transmits the reservation information of the use reservation to the server 20 through the communication unit 11.

Step S103: The controller 15 determines whether the occurrence of the cancellation of the use reservation is detected. When determination is made that the occurrence of the cancellation is detected (Yes in step S103), the process proceeds to step S104. On the other hand, when determination is made that the occurrence of the cancellation is not detected (No in step S103), the process repeats step S103.

Step S104: The controller 15 determines whether a time from the cancellation occurrence time point to the reservation start time point of the use reservation is less than the threshold value. When determination is made that the time is less than the threshold value (Yes in step S104), the process proceeds to step S105. On the other hand, when determination is made that the time is equal to or larger than the threshold value (No in step S104), the process proceeds to step S106.

Step S105: The controller 15 transmits the cancellation information of the use reservation to the server 20 through the communication unit 11.

Step S106: The controller 15 deletes the reservation information stored in the storage unit 12.

### Operation Flow of Server

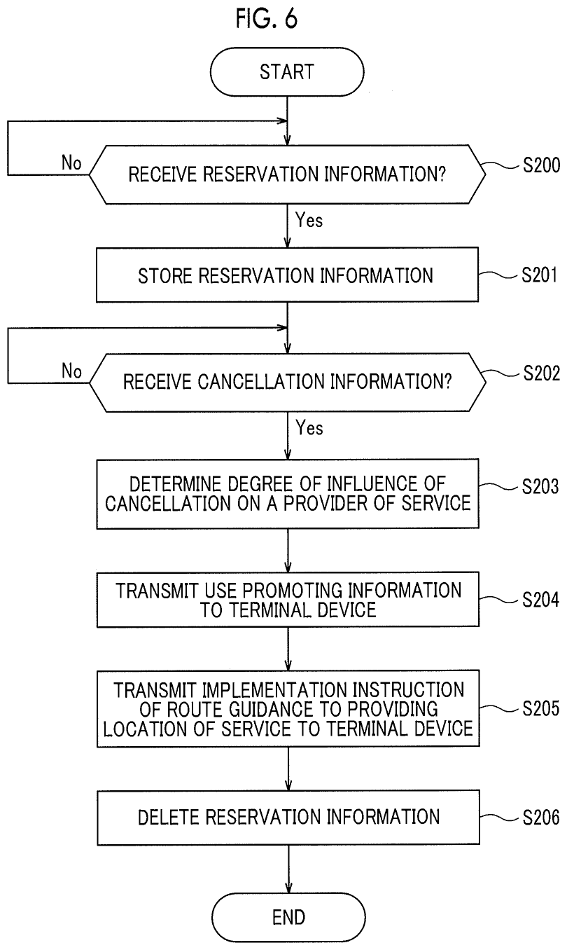

An operation flow of the server 20 will be described with reference to FIG. 6.

Step S200: The server controller 23 determines whether the reservation information is received from the reservation system 10. When determination is made that the reservation information is received (Yes in step S200), the process proceeds to step

S201. On the other hand, when determination is made that the reservation information is not received (No in step S200), the process repeats step S200.

Step S201: The server controller 23 accumulates the received reservation information in the database of the server storage unit 22.

Step S202: The server controller 23 determines whether the cancellation information of the use reservation is received from the reservation system 10. When determination is made that the cancellation information is received (Yes in step S202), the process proceeds to step S203. On the other hand, when determination is made that the cancellation information is not received (No in step S202), the process repeats step S202.

Step S203: The server controller 23 determines the degree of influence of the cancellation on the service provider.

Step S204: The server controller 23 transmits the use promoting information, to the terminal device 30 of the user, that enables the service user to use the service under a beneficial condition as the degree of influence is greater.

Step S205: The server controller 23 transmits the implementation instruction of the route guidance to the service providing location to the terminal device 30.

Step S206: The server controller 23 deletes the reservation information related to the canceled use reservation from the database of the server storage unit 22.

As described above, in the information processing system 1 according to the embodiment, the reservation system 10 transmits the reservation information including the identification information of the use reservation (reservation ID) to the server 20 when the occurrence of the use reservation of the service is detected, and transmits the cancellation information including the identification information of the use reservation to the server 20 when the occurrence of the cancellation of the use reservation is detected. When the reservation information is received from the reservation system 10, the server 20 stores the reservation information. When the cancellation information is received from the reservation system 10, the server 20 determines the degree of influence of the cancellation on the service provider and transmits the use promoting information, to the terminal device 30 of the user, that enables the service user to use the service under a beneficial condition as the degree of influence is greater.

With the related configuration, even when the cancellation of the use reservation of the service occurs, the occurrence of the lost profits or loss of the service provider may be avoided by the customer attraction effect of the use promoting information according to the degree of influence. Therefore, the influence of the reservation cancellation on the service provider may be reduced.

The disclosure is described based on the drawings and the examples, but it is to be noted that those skilled in the art easily perform various modifications and changes based on this disclosure. Therefore, it is to be noted that these modifications and changes are included in the scope of the disclosure. For example, the functions and the like included in each means, each step, or the like can be disposed again so as not to be logically contradictory, and a plurality of means, steps, or the like can be combined into one, or divided.

For example, in the embodiment described above, the reservation system 10 and the server 20 may be integrated.

One or more general purpose information processing devices such as a smartphone, a computer, or the like can be configured to function as the reservation system 10 or the server 20 according to the embodiment described above. Specifically, a program, in which processing contents for realizing each function of the reservation system 10 and the like according to the embodiment are described, is stored in a memory of the information processing device, and a processor of the information processing device reads and executes the program. Therefore, the disclosure according to the embodiment can also be realized as the program that can be executed by the processor.

What is claimed is:

1. An information processing system comprising:
a reservation system that manages a use reservation of a service; and
a server configured to communicate with the reservation system, wherein:
the reservation system is configured to
transmit, to the server, reservation information including identification information of the use reservation when an occurrence of the use reservation of the service is detected by the reservation system, and
transmit, to the server, cancellation information including the identification information of the use reservation when an occurrence of a cancellation of the use reservation is detected by the reservation system; and
the server is configured to
store the reservation information when the reservation information is received from the reservation system,
determine a degree of influence of the cancellation on a provider of the service when the cancellation information is received from the reservation system, and
transmit, to a terminal device of a user, use promoting information that enables a service user to use the service under a more beneficial condition as the degree of influence is greater.

2. The information processing system according to claim 1, wherein:
the reservation information includes the number of reservation people of the use reservation; and
the server is configured to determine that the degree of influence is greater as the number of reservation people of the canceled use reservation is larger.

3. The information processing system according to claim 1, wherein:
the reservation information includes a reservation start time point of the use reservation;
the cancellation information includes a cancellation occurrence time point of the use reservation; and
the server is configured to determine that the degree of influence is greater as a time from the cancellation occurrence time point to the reservation start time point is shorter.

4. The information processing system according to claim 1, wherein the reservation system is configured to transmit, to the server, the cancellation information when the cancellation occurs and a time from a cancellation occurrence time point to a reservation start time point of the use reservation is less than a predetermined threshold value.

5. The information processing system according to claim 1, wherein:
the reservation information includes a reservation start time point and a reservation end time point of the use reservation; and
a valid period is set in the use promoting information, the valid period being from the reservation start time point to the reservation end time point of the canceled use reservation.

6. The information processing system according to claim 1, wherein the server is configured to transmit, to the terminal device, an instruction for implementing route guidance to a location where the service is provided.

7. A non-transitory storage medium storing a program causing a server configured to communicate with a reservation system that manages a use reservation of a service to execute:
receiving reservation information including identification information of the use reservation from the reservation system that detects an occurrence of the use reservation of the service;
storing the received reservation information;
receiving cancellation information including the identification information of the use reservation from the reservation system that detects an occurrence of a cancellation of the use reservation;
determining a degree of influence of the cancellation on a provider of the service; and
transmitting, to a terminal device of a user, use promoting information that enables a service user to use the service under a more beneficial condition as the degree of influence is greater.

8. An information processing method comprising:
causing a reservation system that manages a use reservation of a service to transmit, to a server configured to communicate with the reservation system, reservation information including identification information of the use reservation of the service when an occurrence of the use reservation of the service is detected by the reservation system;
causing the server to store the reservation information when the server receives the reservation information from the reservation system;
causing the reservation system to transmit, to the server, cancellation information including the identification information of the use reservation when an occurrence of a cancellation of the use reservation is detected by the reservation system;
causing the server to determine a degree of influence of the cancellation on a provider of the service when the cancellation information is received from the reservation system; and
causing the server to transmit, to a terminal device of a user, use promoting information that enables a service user to use the service under a more beneficial condition as the degree of influence is greater.
